(19) United States
(12) Patent Application Publication
(10) Pub. No.: US 2014/0084040 A1
(43) Pub. Date: Mar. 27, 2014

(54) METHOD AND APPARATUS FOR SEPARATING WORKPIECES

(71) Applicant: ELECTRO SCIENTIFIC INDUSTRIES, INC., Portland, OR (US)

(72) Inventors: Haibin Zhang, Portland, OR (US); Glenn Simenson, Portland, OR (US); Qian XU, Portland, OR (US); Hisashi Matsumoto, Portland, OR (US)

(73) Assignee: ELECTRO SCIENTIFIC INDUSTRIES, INC., Portland, OR (US)

(21) Appl. No.: 14/033,305

(22) Filed: Sep. 20, 2013

Related U.S. Application Data
(60) Provisional application No. 61/704,968, filed on Sep. 24, 2012.

(51) Int. Cl. B26F 3/00

(52) U.S. Cl. CPC B26F 3/00
USPC 225/3; 225/93

(57) ABSTRACT

The invention is an apparatus, for performing the method, and the method including the steps of providing a workpiece, contacting a portion of an exterior surface of the workpiece to an acoustic couplant such that an interface between the acoustic couplant and the portion of the exterior surface is at least substantially continuous across the portion of the exterior surface, and propagating a crack through the workpiece. A portion of the acoustic couplant at the interface has acoustic impedance relative to the acoustic energy that is greater than 400 kg·m⁻²·s⁻¹.

### CROSS REFERENCE TO RELATED APPLICATIONS

This application is a Non-Provisional application which claims benefit of U.S. Patent Provisional Application Ser. No. 61/704,968, which was filed on 24 Sep. 2012, the contents of which are herein incorporated by reference in their entirety for all purposes.

### BACKGROUND

Embodiments of the present invention relate generally to methods and apparatus for separating workpieces and, more specifically, to methods for separating workpieces into unit pieces having different sizes, geometries, and the like.

It can be difficult to asymmetrically cut or separate brittle workpieces along a desired separation path. For example, cracks propagating through the workpiece tend to undesirably veer away from the desired separation path when the path is closer to one side of the workpiece than another. This phenomenon is especially noticeable with workpieces formed of chemically strengthened glass, which can have compressive surface stresses of up to 1 GPa. To avoid this problem, workpieces have typically been separated only symmetrically (i.e., by dividing the material into two equal pieces and, if necessary, dividing subsequently formed pieces in half). Separating workpieces by this method, however, can place an unreasonable restriction on the size and shape of the pieces ultimately formed, as well as on the separation process itself.

### BRIEF DESCRIPTION OF THE DRAWINGS

FIGS. 1 to 3 schematically illustrate mechanisms influencing desirable propagation of a crack within a workpiece along a defined separation path when a workpiece is symmetrically separated.

FIGS. 4 and 5 schematically illustrate mechanisms influencing undesirable propagation of a crack within a workpiece along an actual separation path that deviates from a defined separation path when a workpiece is asymmetrically separated.

FIGS. 6 and 7 schematically illustrate a method of asymmetrically separating a workpiece according to one embodiment.

FIG. 8 schematically illustrates one embodiment of an apparatus for asymmetrically separating a workpiece.

### DETAILED DESCRIPTION OF THE ILLUSTRATED EMBODIMENTS

Embodiments of the present invention are described more fully hereinafter with reference to the accompanying drawings, in which example embodiments of the invention are shown. These embodiments may, however, be implemented in many different forms and should not be construed as limited to the embodiments set forth herein. Rather, the embodiments are provided so that this disclosure will be thorough and complete, and will fully convey the scope of the invention to those skilled in the art. In the drawings, the shapes, sizes and relative sizes of layers, regions, components, may be exaggerated for clarity. Unless otherwise specified, a range of values, when recited, includes both the upper and lower limits of the range, as well as any sub-ranges there between.

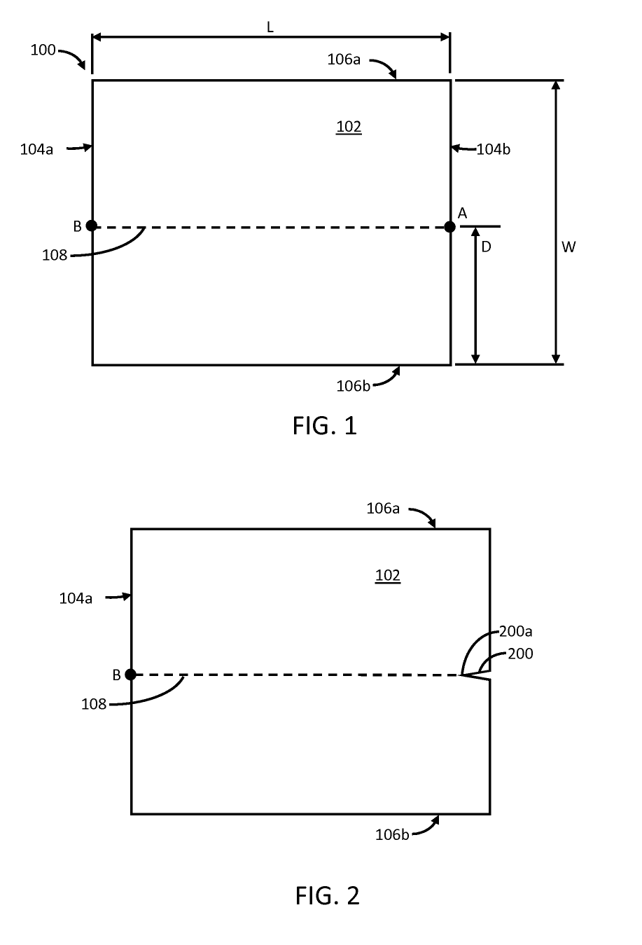

Referring to FIG. 1, a workpiece 100 includes an exterior surface having a first primary surface region 102, a second primary surface region (not shown) opposite the first primary surface region 102, and one or more edge surface regions extending from the first primary surface region 102 to the second primary surface region. As exemplarily illustrated however, the workpiece 100 includes a first pair of opposing edge surface regions 104a and 104b and a second pair of opposing edge surface regions 106a and 106b. For purposes of discussion herein, the distance between the first pair of opposing edge surface regions 104a and 104b can be characterized as the length (L) of the workpiece 100, and the distance between the second pair of opposing edge surface regions 106a and 106b can be characterized as the width (W) of the workpiece 100. Generally, the length L of the workpiece 100 may be greater than or equal to the width W of the workpiece 100. In one embodiment, length L of the workpiece 100 may be in a range from 20 mm to 1000 mm (or may be less than 20 mm or greater than 1000 mm).

In the illustrated embodiment, the first primary surface region 102 and the second primary surface region are both substantially flat are parallel to one another. Accordingly, the distance from the first primary surface region 102 and the second primary surface region can define the thickness of the workpiece 100. In one embodiment, the thickness of the workpiece is in a range from 200 μm to 10 mm. In another embodiment, however, the thickness of the workpiece can be less than 200 μm or greater than 10 mm. In yet another embodiment, the first primary surface region 102 and the second primary surface region may not be substantially flat, may not be parallel to one another, or a combination thereof.

Generally, the workpiece 100 is formed of a brittle material such as sapphire, silicon, a ceramic, a glass, a glass-ceramic, or the like or a combination thereof. In one embodiment, the workpiece 100 is provided as a sheet of glass (e.g., thermally strengthened glass, chemically strengthened glass, or unstrengthened glass). The sheet of glass can be formed of any glass composition such as soda-lime glass, borosilicate glass, aluminosilicate glass, aluminoborosilicate glass, sodium-aluminosilicate glass, calcium-aluminosilicate glass, phosphate glass, fluoride glass, chalcogenide glass, bulk metallic glass, or the like, or a combination thereof. When the sheet of glass is strengthened, each of the first primary surface region 102 and the second primary surface region can be compressively stressed while a region in the interior of the sheet of glass is in a state of tension to compensate for the surface compression at the first primary surface region 102 and the second primary surface region. Thus, the sheet of strengthened glass can be characterized as including a pair of compression regions (i.e., regions where the glass is in a state of compression) extending from the first primary surface region 102 and the second primary surface region and separated by a central tension region (i.e., a regions where the glass is in a state of tension). The thickness of a compression region is known as the “depth of layer” (DOL).

Generally, the surface compression at each of the first primary surface region 102 and the second primary surface region can be in a range from 69 MPa to 1 GPa. In other embodiments, however, the surface compression at any of the first primary surface region 102 or second primary surface region can be less than 69 MPa or greater than 1 GPa. Generally, the DOL can be in a range from 20 μm to 100 μm. In other embodiments, however, the DOL can be less than 20 μm or greater than 100 μm. The maximum tensile stress of the sheet within the tension region can be determined by the following formula:

$$CT = \frac{CS \times DOL}{t - 2 \times DOL}$$

CS is the aforementioned surface compression at the first primary surface region 102 and second primary surface region, t is the thickness of the sheet of glass (expressed in millimeters, mm), DOL is the depth of layer of the compression region(s) (expressed in mm), and CT is the maximum central tension within the sheet of glass (expressed in MPa).

Having exemplarily described a workpiece 100 capable of being separated according to embodiments of the present invention, exemplary embodiments of separating the workpiece 100 will now be described. Upon implementing these methods, the workpiece 100 can be separated along a desired separation path such as separation path 108. As exemplarily illustrated, the separation path 108 extends along a straight line, completely between the first pair of edge surface regions 104a and 104b (e.g., between points A and B). In other embodiments, however, the desired separation path may extend along a curved line, may be spaced apart from one or both of the edge surface regions 104a and 104b, or a combination thereof. As exemplarily illustrated, the separation path 108 parallel to the second pair of edge surface regions 106a and 106b such that the separation path 108 is spaced apart from an edge surface region (e.g., edge surface region 106b) by a distance D, wherein D is approximately half of W. In other embodiments, however, that is not parallel to the edge surface region 106a or edge surface region 106b. Further as will be discussed in greater detail below, the distance from which the separation path 108 is spaced apart from edge regions such as edge surface region 106a and 106b may be less than half of W (e.g., in a range from about 1% to about 40% of W).

In one embodiment, the workpiece 100 can be separated along the separation path 108 by first defining the separation path 108. The separation path 108 represents a region within the workpiece 100 having one or properties (e.g., defect density, stress states, temperature, composition, etc.) different from properties in the remaining bulk of the workpiece 100. The property differences are significant enough to guide or otherwise influence the path that a crack (once initiated) will propagate through the workpiece 100. Generally, however, the separation path 108 can be defined by mechanically scribing a portion of one or both of the first and second primary surface regions, chemically etching a portion of one or both of the first and second primary surface regions, heating a portion of one or both of the first and second primary surface regions, cooling a portion of one or both of the first and second primary surface regions, subjecting the workpiece 100 to a bending moment, modifying material within the interior of the workpiece 100 (e.g., as described in International Patent Publication No. WO 2012/006736 A2, which is incorporated herein by reference).

In one embodiment, the separation path 108 can be defined by performing one or more processes as described in any of U.S. Provisional Application No. 61/604,380, filed Feb. 28, 2012, U.S. Provisional Application No. 61/604,416 filed Feb. 28, 2012, U.S. Patent App. Pub. No. 2011/0226832 A1, published Sep. 22, 2011, U.S. Patent App. Pub. No. 2011/0127244 A1, published Jun. 2, 2011, U.S. Patent App. Pub. No. 2011/0049765 A1, published Mar. 3, 2011, U.S. Pat. No. 6,992,026, issued Jan. 31, 2006, U.S. Pat. No. 5,826,772, issued Oct. 27, 1998, all of which are incorporated herein by reference in their entirety. In one embodiment, the separation path 108 can be defined by the directing laser energy onto a portion of the workpiece 100 (e.g., to induce vaporization, ionization, ablation, heating, or the like or a combination thereof, of material within the workpiece 100).

In one embodiment, the laser energy can have one or more wavelengths of light in a range from 100 nm to 11 μm (e.g., 266 nm, 523 nm, 532 nm, 543 nm, 780 nm, 800 nm, 1064 nm, 1550 nm, 10.6 μm, etc.). For example, the laser energy can have one or more wavelengths of light in a range from 100 nm to 11 μm (e.g., 266 nm, 523 nm, 532 nm, 543 nm, 780 nm, 800 nm, 1064 nm, 1550 nm, 10.6 μm, etc.), depending on the material from which the workpiece 100 is formed. In another example, the laser energy can be in form of at least one pulse of light having pulse duration in a range from 10 fs to 500 ns (or less than 10 fs or more than 500 ns) and a pulse repetition rate in a range from 10 Hz to 100 MHz (or less than 10 Hz or more than 100 MHz).

Referring to FIG. 2, the workpiece 100 may be separated along the separation path 108 by first forming an initiation defect within the workpiece 100 and then propagating a crack through the workpiece 100 from the initiation defect. It will be appreciated that the separation process may be initiated while the separation path 108 is being defined, or may be initiated after the separation path 108 has been defined. In some embodiments, the initiation defect can be one or more cracks, grooves, dislocations, grain boundaries, voids, color centers, or the like or a combination thereof.

Generally, the initiation defect can be defined by mechanically scribing a portion of the workpiece 100 (e.g., at the first primary surface region 102, the second primary surface region, the edge surface region 104b, or the like or a combination thereof) at a location at or near point A, chemically etching a portion of the workpiece 100 (e.g., at the first primary surface region 102, the second primary surface region, the edge surface region 104b, or the like or a combination thereof) heating a portion of the workpiece 100 (e.g., at the first primary surface region 102, the second primary surface region, the edge surface region 104b, or the like or a combination thereof) at a location at or near point A, cooling a portion of the workpiece 100 (e.g., at the first primary surface region 102, the second primary surface region, the edge surface region 104b, or the like or a combination thereof) at a location at or near point A, subjecting a portion of the workpiece 100 (e.g., at the first primary surface region 102, the second primary surface region, the edge surface region 104b, or the like or a combination thereof) at a location at or near point A to a bending moment, modifying material within the interior of the workpiece 100 at a location at or near point A (e.g., as described in International Patent Publication No. WO 2012/006736 A2, which is incorporated herein by reference), or the like, or a combination thereof. In one embodiment, the initiation defect can be formed by applying laser energy onto a portion of the workpiece. In such an embodiment, the laser energy used in forming the initiation defect can have characteristics (e.g., wavelength, pulse duration, pulse repetition rate, or the like or a combination thereof) that are the same as or different from the laser energy characteristics used in defining the separation path 108.

In one embodiment, the initiation defect is configured so that a crack, such as crack 200, having a crack tip 200a extending generally from the first primary surface region 102 to the second primary surface region, propagates through the workpiece 100 (e.g., along the desired separation path from desired start point A to desired end point B, as shown in FIG. 1) immediately after the initiation defect is formed. For example, in embodiments in which the workpiece is a sheet of strengthened glass, the initiation defect may be provided as a groove or crack that extends from the first primary surface 102 or the second primary surface sufficiently close to (or into) the tension region to create a localized region of maximum tensile stress that creates the crack 200.

In another embodiment, the initiation defect is configured that that a crack such as crack 200 propagates through the workpiece 100 (e.g., along the desired separation path from desired start point A to desired end point B, as shown in FIG. 1) upon heating the workpiece 100 at a location at or near the initiation defect, cooling the workpiece 100 at a location at or near the initiation defect, bending the workpiece 100 at a location at or near the initiation defect, mechanically impacting the workpiece 100 at a location at or near the initiation defect, or the like or a combination thereof. For example, in embodiments in which the workpiece is a sheet of unstrengthened glass, the initiation defect may be provided as blind crack that extends partially through the thickness of the workpiece 100. The crack 200 may then be formed and propagated by subsequently heating (or by cooling followed by heating) the blind crack to form a full body crack. See, e.g., U.S. Pat. No. 6,489,588, issued Dec. 3, 2002, which is incorporated herein by reference in its entirety). Upon propagating the crack 200 along the desired separation path (e.g., from desired start point A to desired end point B, as shown in FIG. 1), the workpiece 100 may be separated into unit pieces, such as unit pieces 300a and 300b as shown in FIG. 3.

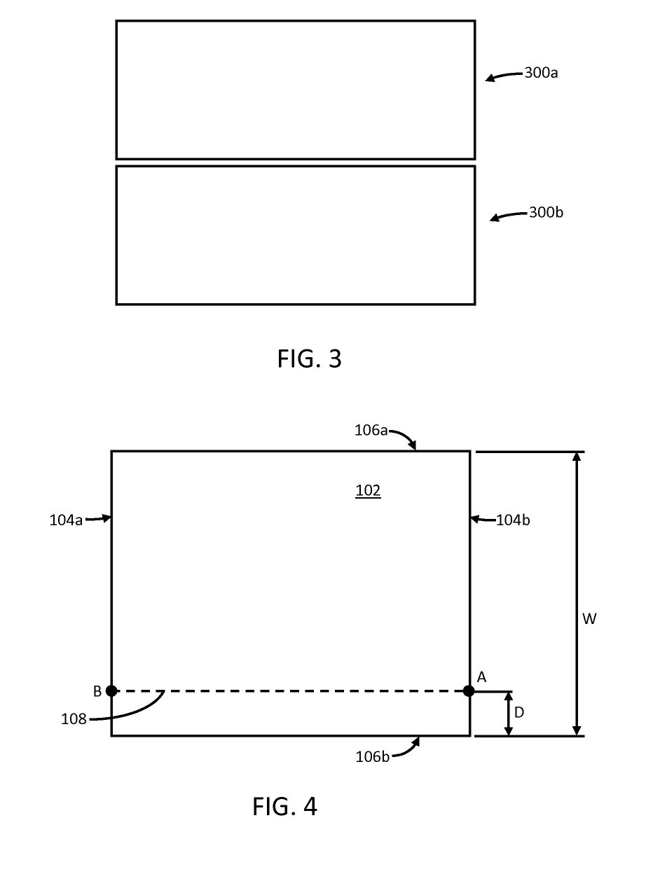

While the workpiece separation process described above with respect to FIGS. 1 to 3 works well when D is approximately half of W, the inventors have discovered that the aforementioned workpiece separation process does not work well when D is less than approximately half of W. For example, the inventors have determined that, when D is approximately half of W, the crack tip 200a of crack 200 travels at least substantially along the desired path of separation 108 so as to arrive at least substantially at the desired end point B. However, when D is less than approximately half of W, the crack tip 200a can veer off the separation path 108 as it travels through the workpiece 100. Depending upon factors such as the length L of the workpiece 100 and how much less D is than approximately half of W, the crack tip 200a can propagate through the workpiece 100 to arrive at a location on the edge surface region 104a that is undesirably far away from the desired end point B, or can even arrive at a location on an edge surface region such as edge surface region 106b. For example, and with reference to FIG. 4, the separation path 108 can be defined in the manner as described above with respect to FIG. 1, but may extend along a straight line, parallel to edge surface region 106b and spaced apart from the edge surface region 106b by a distance D that is in a range from about 1% to about 40% of W. Stated more broadly, the separation path 108 shown in FIG. 4 illustrates one instance in which a minimum distance between a portion of the separation path 108 and a first portion of an edge surface region on a first side of the separation path 108 (i.e., edge surface region 106b) is different from a minimum distance between the portion of the separation path 108 and a second portion of the edge surface region on a second side of the separation path 108 (i.e., edge surface region 106a). As shown in FIG. 5, upon forming an initiation defect and propagating the crack 200 from the initiation defect, the crack tip 200a can propagate some distance along the separation path 108, but then veer off along an undesired separation path such as separation path 500 and terminate at an undesired end point (e.g., an undesired end point C located at edge surface region 106b). Thus it can be difficult to asymmetrically divide the workpiece 100 into unit pieces having different sizes, geometries, and the like, in a desirable and controllable manner.

While not wishing to be bound by any particular theory, the inventors believe that acoustic energy generated at the crack tip 200a (i.e., as the crack 200 propagates through the workpiece 100) is transmitted in one or more directions that are perpendicular to the direction in which the crack 200 propagates. As used herein, the term “acoustic energy” refers to mechanical vibrations within the workpiece 100 generated upon cracking of the material in the workpiece 100 at the crack tip 200a as the crack 200 propagates through the workpiece 200. Thus it is believed that the phenomenon described with respect to FIGS. 4 and 5 may be primarily the result of the interaction between the acoustic energy transmitted from the crack tip 200a through the workpiece 100 as the crack 200 propagates along the separation path 108 and the edge surface regions (or portions thereof) that are relatively close to the separation path 108 and that lie in the path of the transmitted acoustic energy.

In view of the above, the aforementioned workpiece separation process can, according to one embodiment, further include a process of acoustically contacting at least a portion of the workpiece 100 to an acoustic couplant so as to form an energy transmissive interface that is at least substantially continuous so as to enable acoustic energy generated at the crack tip 200a to be transmitted out of the workpiece 100. For purposes of discussion herein, an energy transmissive interface that is “at least substantially continuous” can be either continuous or discontinuous. However if the energy transmissive interface is discontinuous, any gaps between the acoustic couplant and the workpiece 100 should be sufficiently small so as to not cause any significant reflection of acoustic energy back into the workpiece 100.

Generally, the acoustic impedance of the acoustic couplant at the energy transmissive interface will be greater than that of air at 20° C. and 1 atm (i.e., greater than 400 kg·m⁻²·s⁻¹). Further, the acoustic impedance of the acoustic couplant at the energy transmissive interface can be selected such that the reflection coefficient, R, at the energy transmissive interface is less than 0.98, less than 0.95, less than 0.9, less than 0.85, less than 0.8, less than 0.5, or even less than 0.3. For purposes of discussion, R, can be calculated as follows:

$$R = {\vert \frac{Z 1 - Z 2}{Z 1 + Z 2} \vert}^{2}$$

where Z1 is the acoustic impedance of the workpiece 100, Z2 is the acoustic impedance of the acoustic couplant at the energy transmissive interface. Generally, the acoustic impedance of the acoustic couplant at the energy transmissive interface (i.e., Z2) may be less than or equal to the acoustic impedance of the workpiece (i.e., Z1). In one embodiment, Z2 (when measured at 20° C. and 1 atm) may be in a range from 1·(10⁶) kg·m⁻²·s⁻¹ to 20·(10⁶) kg·m⁻²·s⁻¹. In other embodiments, however, the acoustic impedance of the portion of the acoustic couplant at the aforementioned interface may be greater than the acoustic impedance of the workpiece 100.

The acoustic couplant may include one or more materials such as a liquid (e.g., water, oil (e.g., SAE 20), silicone oil, glycerin, propylene glycol, ethylene glycol, or the like or a combination thereof), a gel (e.g., glycerin, honey, or the like or a combination thereof), a grease (e.g., brown grease, silicone grease, petroleum jelly, or the like or a combination thereof), an elastomer compound (e.g., silicone, or the like), an adhesive (e.g., silicone adhesive, hot-melt glue, cyanoacrylate, dental cement, wax beads, or the like or a combination thereof), or the like or a combination thereof. Liquid-based acoustic couplants are generally suitable when the exterior surface of the workpiece 100 is relatively smooth, gels and greases are generally suitable when the exterior surface of the workpiece 100 is relatively rough. If possible, it is desirable to clean the exterior surface of the workpiece 100 to remove dust and other particles that may trap air at the interface between the workpiece 100 and the acoustic couplant.

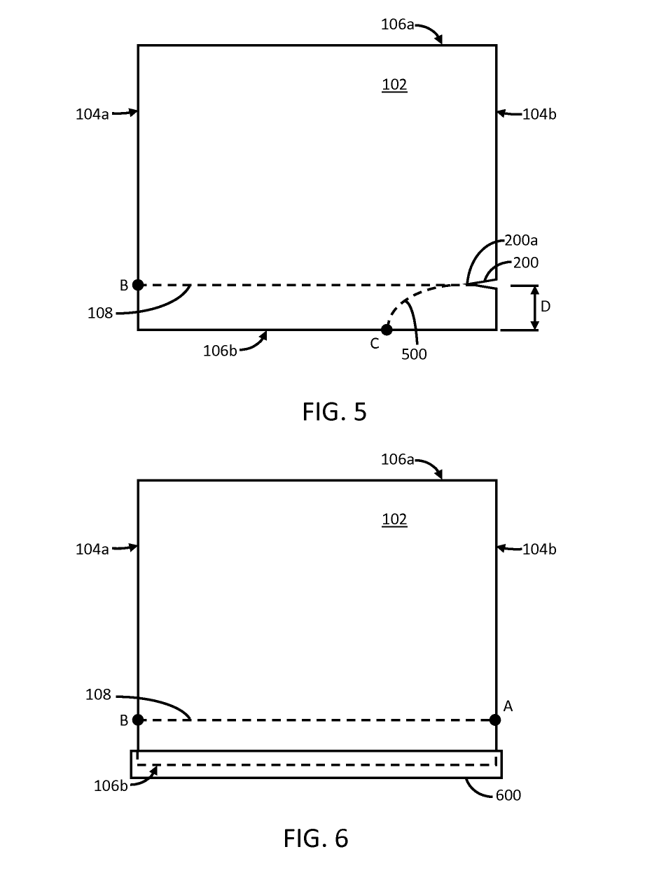

Referring to FIG. 6, one or more of the acoustic couplants as exemplarily described above, collectively and generically referred to herein simply as an acoustic couplant 600, may be contacted to the exterior surface workpiece 100 either before, during or after the separation path 108 is defined. Although FIG. 6 illustrates the acoustic couplant 600 as contacting the edge surface regions 104a, 104b and 106b, it will be appreciated that the acoustic couplant 600 may contact only the edge surface region 106b. Although FIG. 6 illustrates the acoustic couplant 600 as contacting the edge surface region 106b along the entire length of the separation path 108, it will be appreciated that the acoustic couplant 600 may contact only a portion of edge surface region 106b. In the illustrated embodiment, the acoustic couplant 600 is illustrated as contacting a portion of the first primary surface region 104a. However, it will be appreciated that the acoustic couplant 600 may contact any other portion of the first primary surface 102 or all of the first primary surface 102. Similarly, the acoustic couplant 600 may contact any portion of, or all of, the second primary surface region. Upon propagating the crack 200 along the desired separation path (e.g., from desired start point A to desired end point B, as shown in FIG. 6), the workpiece 100 may be asymmetrically separated into unit pieces, such as unit pieces 700a and 700b as shown in FIG. 7. The resulting unit pieces, such as unit pieces 700a and 700b can have different sizes, geometries and the like. After separating the workpiece 100 into unit pieces 700a and 700b, the acoustic couplant 600 may be removed by from one or more of the unit pieces by any suitable method (e.g., by washing with a solvent such as water, depending on the material of the acoustic couplant).

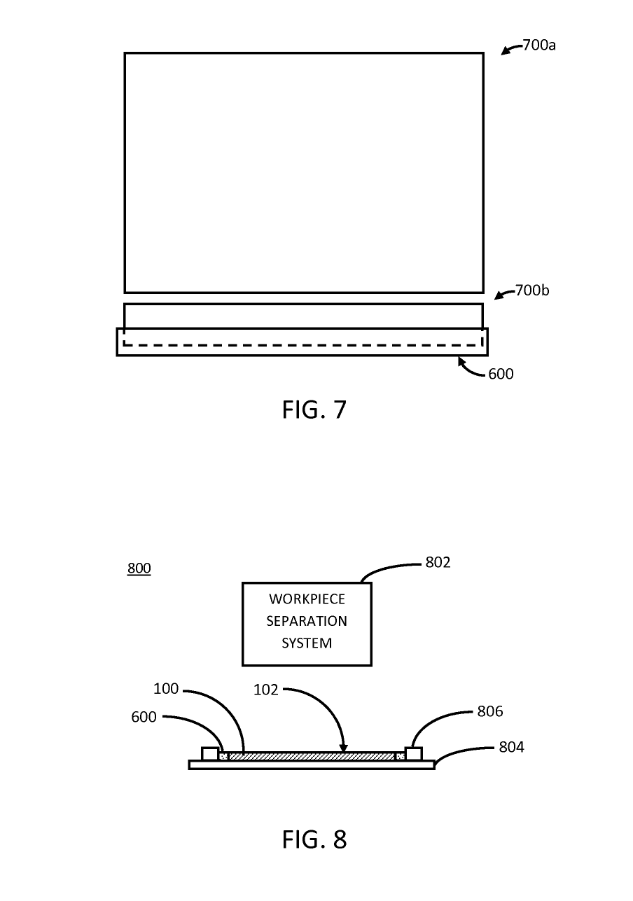

Having exemplarily described exemplary embodiments of a workpiece separation process, exemplary embodiments of an apparatus for separating the workpiece 100 will now be described with reference to FIG. 8.

Referring to FIG. 8, a workpiece separation apparatus, such as workpiece separation apparatus 800, may include a workpiece separation system 802 configured to separate the aforementioned workpiece 100 according to one or more of the embodiments discussed above, a workpiece support 804 configured to support the workpiece 100, and the aforementioned acoustic couplant 600 configured to acoustically contact the workpiece 100.

In embodiments in which the acoustic couplant 600 is a liquid, gel, grease, or the like, the apparatus 800 may further include a dam 806 configured to retain at least a portion of the acoustic couplant 600 (e.g., to prevent the acoustic couplant 600 from spilling or otherwise flowing undesirably away from the workpiece 100). Although FIG. 8 illustrates the first primary surface region 102 as not being contacted by the acoustic couplant 600, the first primary surface region 102 may be contacted by the acoustic couplant 600. In one embodiment, the workpiece 100 may be submerged within the acoustic couplant 600 such that the first primary surface region 102, one or more of the edge surface regions and, optionally, the second primary surface region, are contacted by the acoustic couplant 600 (e.g., provided as any suitable liquid).

In one embodiment, the workpiece 100 may be introduced to the apparatus 800 by first disposing the workpiece 100 on the workpiece support 804 such that the first primary surface region 102 faces away from the workpiece support 804 and the second primary surface region faces toward the workpiece support 804, and subsequently contacting a portion of the exterior surface to the acoustic couplant 600 (e.g., the first primary surface region 102, one or more of the edge surface regions, or the like or a combination thereof). In another embodiment, however, the acoustic couplant 600 may first be disposed on the workpiece support 804 (e.g., so as to be retained by the dam 806) and then the workpiece 100 may be disposed on the workpiece support 804 such that the acoustic couplant 600 is disposed between the workpiece 100 and the workpiece support 804. In yet another embodiment, the acoustic couplant 600 may first be disposed on the workpiece 100 and then the workpiece 100 having the acoustic couplant 600 contacted thereto can be disposed on the workpiece support 804.

The foregoing is illustrative of embodiments of the invention and is not to be construed as limiting thereof. Although a few example embodiments of the invention have been described, those skilled in the art will readily appreciate that many modifications are possible in the example embodiments without materially departing from the novel teachings and advantages of the invention. In view of the foregoing, it is to be understood that the foregoing is illustrative of the invention and is not to be construed as limited to the specific example embodiments of the invention disclosed, and that modifications to the disclosed example embodiments, as well as other embodiments, are intended to be included within the scope of the appended claims. The invention is defined by the following claims, with equivalents of the claims to be included therein.

What is claimed is:

1. A method, comprising:
providing a workpiece having an exterior surface;
defining a separation path within the workpiece;
separating the workpiece along the separation path such that acoustic energy is generated within the workpiece during the separating and transmitted toward a portion of the exterior surface; and
during the separating, contacting the portion of the exterior surface to an acoustic couplant such that an interface between the acoustic couplant and the portion of the exterior surface is at least substantially continuous across the portion of the exterior surface,
wherein a portion of the acoustic couplant at the interface has an acoustic impedance relative to the acoustic energy that is greater than 400 kg·m⁻²·s⁻¹.

2. A method, comprising:
providing a workpiece having an exterior surface;
contacting a portion of the exterior surface to an acoustic couplant such that an interface between the acoustic couplant and the portion of the exterior surface is at least substantially continuous across the portion of the exterior surface; and
propagating a crack through the workpiece having the acoustic couplant contacted thereto,
wherein a portion of the acoustic couplant at the interface has an acoustic impedance relative to the acoustic energy that is greater than 400 kg·m⁻²·s⁻¹.

3. A method, comprising:
providing a workpiece having an exterior surface;
contacting a portion of the exterior surface to an acoustic couplant, the acoustic couplant including at least one material selected from the group consisting of a liquid, a gel, an elastomer compound, an adhesive and a grease; and
propagating a crack through the workpiece having the acoustic couplant contacted thereto.

4. The method of any of claims 1, wherein workpiece has a thickness greater than 200 μm.

5. The method of any of claims 1, wherein the workpiece has a thickness less than 10 mm.

6. The method of any of claims 1, wherein the workpiece comprises a brittle material.

7. The method of any of claims 1, wherein the brittle material comprises sapphire.

8. The method of any of claims 1, wherein the brittle material comprises silicon.

9. The method of any of claims 1, wherein the brittle material comprises a ceramic.

10. The method of any of claims 1, wherein the workpiece comprises a sheet of glass.

11. The method of claim 10, wherein the sheet of glass comprises thermally strengthened glass.

12. The method of any of claims 10, wherein the sheet of glass comprises chemically strengthened glass.

13. The method of any of claims 10, wherein a first portion of the exterior surface is compressively stressed.

14. The method of claim 13, wherein the first portion of the exterior surface is compressively stressed at a stress of greater than 69 MPa.

15. The method of any of claims 13, wherein the first portion of the exterior surface is compressively stressed at a stress of greater than 100 MPa.

16. The method of any of claims 13, wherein the first portion of the exterior surface is compressively stressed at a stress of greater than 600 MPa.

17. The method of any of claims 13, wherein the sheet of glass includes a compressively-stressed region extending from the first portion of the exterior surface into the interior of the sheet of glass, wherein a thickness of the compressively-stressed region is greater than 20 μm.

18. The method of claim 17, wherein the thickness of the compressively-stressed region is greater than 40 μm.

19. The method of any of claims 17, wherein the thickness of the compressively-stressed region is greater than 50 μm.

20. The method of any of claims 17, wherein the thickness of the compressively-stressed region is greater than 100 μm.

21. The method of any of claims 13, wherein a second portion of the exterior surface opposite the first portion is compressively stressed.

22. The method of any of claims 10, wherein an interior region of the sheet of glass is in a state of tension.

23. The method of any of claims 1, wherein defining the separation path comprises mechanically scribing a portion of the exterior surface of the workpiece.

24. The method of any of claims 1, wherein defining the separation path comprises directing laser energy onto a portion of the workpiece.

25. The method of any of claims 1, wherein defining the separation path comprises heating a portion of the exterior surface of the workpiece.

26. The method of any of claims 1, wherein defining the separation path comprises cooling a portion of the exterior surface of the workpiece.

27. The method of any of claims 1, wherein defining the separation path comprises subjecting the workpiece to a bending moment.

28. The method of any of claims 1, wherein defining the separation path comprises chemically etching a portion of the exterior surface of the workpiece.

29. The method of any of claims 1, wherein defining the separation path comprises modifying material within an interior of the workpiece.

30. The method of any of claims 1, wherein
the exterior surface of the workpiece includes a substantially flat first primary surface region, a substantially flat second primary surface region opposite the first primary surface region, and an edge surface region extending from the first primary surface region to the second primary surface region, and
a minimum distance between a portion of the separation path and a first portion of the edge surface region on a first side of the separation path is different from a minimum distance between the portion of the separation path and a second portion of the edge surface region on a second side of the separation path.

31. The method of any of claims 1, wherein separating the workpiece along the separation path comprises forming an initiation defect within the workpiece.

32. The method of claim 30, wherein forming the initiation defect comprises mechanically scribing a portion of the workpiece.

33. The method of any of claims 31, wherein forming the initiation defect comprises directing laser energy onto a portion of the workpiece.

34. The method of any of claims 31, wherein forming the initiation defect comprises heating a portion of the workpiece.

35. The method of any of claims 31, wherein forming the initiation defect comprises cooling a portion of the workpiece.

36. The method of any of claims 31, wherein forming the initiation defect comprises chemically etching a portion of the workpiece.

37. The method of any of claims 31, wherein the initiation defect includes at least one of a crack, a groove, a dislocation, a grain boundary, a void, and a color center.

38. The method of any of claims 31, wherein separating the workpiece along the separation path further comprises propagating a crack through the workpiece from the initiation defect.

39. The method of any of claims 31, wherein separating the workpiece along the separation path further comprises propagating a crack through the workpiece.

40. The method of any of claims 1, wherein separating the workpiece along the separation path further comprises asymmetrically dividing the workpiece.

41. The method of any of claims 1, wherein
the exterior surface of the workpiece includes a substantially flat first primary surface region, a substantially flat second primary surface region opposite the first primary surface region, and an edge surface region extending from the first primary surface region to the second primary surface region, and
contacting the portion of the exterior surface to an acoustic couplant comprises contacting the acoustic couplant to an area of the edge surface region.

42. The method of any of claims 1, wherein
the exterior surface of the workpiece includes a substantially flat first primary surface region, a substantially flat second primary surface region opposite the first primary surface region, and an edge surface region extending from the first primary surface region to the second primary surface region, and
contacting the portion of the exterior surface to an acoustic couplant comprises contacting the acoustic couplant to an area of at least one selected from the group consisting of the first primary surface region and the second primary surface region.

43. The method of any of claims 1, wherein
the exterior surface of the workpiece includes a first primary surface region, a second primary surface region opposite the first primary surface region, and an edge surface region extending from the first primary surface region to the second primary surface region,
providing the workpiece comprises disposing the workpiece on a workpiece support such that the first primary surface region faces away from the workpiece support and the second primary surface region faces toward the workpiece support, and
contacting the portion of the exterior surface to the acoustic couplant comprises contacting the acoustic couplant to an area of at least one selected from the group consisting of the first primary surface region, the second primary surface region and the edge surface region.

44. The method of claim 43, further comprising providing the workpiece and the acoustic couplant such that the acoustic couplant is disposed between the workpiece support and the workpiece.

45. The method of any of claims 43, further comprising disposing the workpiece on the workpiece support and, thereafter, contacting the portion of the exterior surface to the acoustic couplant.

46. The method of any of claims 43, further comprising contacting the portion of the exterior surface to the acoustic couplant and, thereafter, disposing the workpiece on the workpiece support.

47. The method of any of claims 1, wherein the acoustic impedance of the portion of the acoustic couplant at the interface is greater than 1·(106) kg·m⁻²·s⁻¹.

48. The method of any of claims 1, wherein the acoustic impedance of the portion of the acoustic couplant at the interface is greater than 5·(10⁶) kg·m⁻²·s⁻¹.

49. The method of any of claims 1, wherein the acoustic impedance of the portion of the acoustic couplant at the interface is greater than 10·(10⁶) kg·m⁻²·s⁻¹.

50. The method of any of claims 1, wherein the acoustic impedance of the portion of the acoustic couplant at the interface is less than 20·(10⁶) kg·m⁻²·s⁻¹.

51. The method of any of claims 1, wherein the acoustic impedance of the portion of the acoustic couplant at the interface is less than 1·(10⁶) kg·m⁻²·s⁻¹.

52. The method of any of claims 1, wherein the portion of the acoustic couplant at the interface comprises a liquid.

53. The method of any of claims 1, wherein the portion of the acoustic couplant at the interface comprises a gel.

54. The method of any of claims 1, wherein the portion of the acoustic couplant at the interface comprises a grease.

55. The method of any of claims 1, wherein the portion of the acoustic couplant at the interface comprises an elastomer compound.

56. The method of any of claims 1, wherein the portion of the acoustic couplant at the interface comprises an adhesive.

57. The method of any of claims 1, further comprising contacting the portion of the exterior surface to the acoustic couplant while defining the separation path.

58. An article of manufacture formed according to a process as claimed in any of claims 1.

59. An apparatus, comprising:
a workpiece support configured to support a workpiece having an exterior surface;
a workpiece separation system configured to separate a workpiece supported by the workpiece support such that acoustic energy is generated within the workpiece and transmitted toward a portion of the exterior surface; and
an acoustic couplant configured to acoustically contact the portion of the exterior surface.

60. The apparatus of claim 59, wherein the workpiece separation system is configured to perform a process as claimed in any of claims 1.

61. The apparatus of any of claims 59, wherein the acoustic couplant includes at least one material selected from the group consisting of a liquid, a gel, an elastomer compound, an adhesive and a grease.

62. The apparatus of any of claims 59, further comprising a dam coupled to the workpiece support, the dam configured to retain at least a portion of the acoustic couplant.
